(19) United States
(12) Patent Application Publication
(10) Pub. No.: US 2026/0285391 A1
(43) Pub. Date: Sep. 24, 2026

(54) OPTICAL LEATHER ON A VEHICLE STEERING WHEEL

(71) Applicant: AUTOLIV DEVELOPMENT AB, Vargarda (SE)

(72) Inventors: Hugues DOURSOUX, Latillé (FR); Olivier BERTRAND, Courcome (FR)

(21) Appl. No.: 19/472,455

(22) PCT Filed: Apr. 4, 2024
(86) PCT No.: PCT/EP2024/059115

§ 371 Date: Oct. 3, 2025

(30) Foreign Application Priority Data
Apr. 4, 2023 (FR) 2303310

(51) Int. Cl. B62D 1/06; B60Q 3/283; B62D 1/04

(52) U.S. Cl. CPC B62D 1/06; B60Q 3/283; B62D 1/046

(57) ABSTRACT

A vehicle steering wheel, including a frame a luminous device arranged to emit light to-wards a user; a flexible cover element at least partially covering the luminous device the flexible cover element being at least partially permeable to light; and a support arranged between the frame and the flexible cover element wherein the flexible cover element comprises at least one protrusion arranged at least par-tially in at least one recess of the support.

### TECHNICAL FIELD OF THE INVENTION

The present invention relates generally to vehicle steering wheels, in particular vehicle steering wheels equipped with a sheath or decorative part and a lighting device.

### PRIOR ART

In the prior art, steering wheels are known to be fitted with a decorative part or sheath.

Document EP3919674 discloses a light-transmitting artificial leather with a mask and an associated manufacturing method.

However, the prior art leather installed on a prior art steering wheel does not guarantee satisfactory support of the leather or that the mask is correctly positioned above the lighting device. Additionally, without a mask, the diffused pattern may appear blurred due to the diffusivity of the material; the further the mask is from the outer surface, the greater the risk of blurring. In addition, if the leather has an opening to let light through, the opening must not form a mark on the leather.

### DISCLOSURE OF THE INVENTION

One aim of the present invention is, in a first aspect, to overcome the drawbacks of the above-mentioned prior art document. Additionally, the invention aims to improve the appearance or perceived quality of a steering wheel coated with a light-permeable material. A vehicle steering wheel is therefore proposed comprising:
a framework,
a lighting device arranged to emit light towards a user,
a flexible cover element at least partially covering the lighting device, the flexible cover element being at least partially permeable to light, and
a support arranged between the frame and the flexible cover element, characterized in that the flexible cover element comprises at least one protuberance arranged at least partially in at least one recess of the support.

This ensures that the cover element is correctly positioned above the lighting device or the light emitted by the device, and avoids the formation of a mark on the cover element. Additionally, this improves the appearance or perceived quality of the steering wheel, which is coated with light-permeable material.

This makes it possible to improve the retention or holding of the flexible covering element in a reduced footprint, while maintaining ease of manufacture and/or assembly.

Light-permeable means that the material allows a user to see light information through the flexible cover element when the lighting device emits light.

The recess (or depression) forms a cavity, that is, a hollow space, more or less wide and more or less deep, closed or not, in a solid body.

According to one embodiment, the flexible cover element may be a sheath.

According to one embodiment, the flexible cover element may comprise a mask, which is preferably arranged so as to face a light diffusion region of the lighting device. The mask can be added after or during (that is, the mask is a layer of the cover) the cover manufacturing operation.

This allows a predetermined pattern to be displayed in sharp focus.

According to one embodiment, the at least one protuberance can be permeable to light.

This allows light to pass through the protuberance and/or display a pattern.

According to one embodiment, the at least one protuberance can be arranged in a region not crossed by the light from the lighting device.

This limits light loss due to the greater thickness of the material through which the light must pass. In fact, the thickness of the cover element is limited in the light region, limiting the loss of light energy or reducing the lack of sharpness.

According to one embodiment, the at least one protuberance can be formed or imprinted entirely with the flexible cover element.

According to one embodiment, the at least one protuberance can be overmolded or glued on the flexible cover element.

According to one embodiment, the protuberance can be manufactured by 3D printing, lithography, sticker bonding, overmolding or any other suitable method.

According to one embodiment, the steering wheel can further comprise an electrical element which is separate from the lighting device and has an opening arranged to house the at least one protuberance.

This completes the functionality of the steering wheel, while ensuring good support and/or positioning of the flexible cover element and the other advantages mentioned.

According to one embodiment, the steering wheel may further comprise a housing having a housing opening which is arranged to house the at least one protuberance, and preferably the housing opening is arranged to diffuse the light of the lighting device.

This optimizes the layout of the steering wheel and provides better light diffusion.

According to one embodiment, the lighting device comprises the housing, which can preferably be made of plastic and/or rigid.

According to one embodiment, the housing opening is also arranged to diffuse the light of the lighting device.

According to one embodiment, the protuberance can be formed or imprinted directly on the cover element, during the cover element manufacturing operation.

According to one embodiment, the protuberance can be overmolded or glued on the cover element, that is, after the cover element has been manufactured.

According to one embodiment, the steering wheel can comprise a heating and/or hand sensor sheath on the steering wheel, comprising an opening arranged to be filled by the protuberance

According to one embodiment, the protuberance can be between 1.5 and 3 mm high.

According to one embodiment, the protuberance can be of any shape to ensure correct positioning (centering) of the cover element on the steering wheel.

According to one embodiment, the cover element may comprise one or more protuberances.

According to one embodiment, the cover element may be an artificial leather.

According to one embodiment, the cover element may comprise an electrically conductive layer arranged to form a proximity sensor or heating element, that is, the electrically conductive layer is implemented during the material (artificial leather) manufacturing method.

A second aspect relates to a motor vehicle comprising a vehicle steering wheel according to the first aspect.

This makes it possible to offer a vehicle with a steering wheel having an optimized footprint and effective holding and/or optimized positioning of the flexible cover element while facilitating manufacture and assembly and having the aforementioned advantages.

### DESCRIPTION OF THE FIGURES

Other features and advantages of the present invention will become more apparent upon reading the following detailed description of embodiments of the invention, which are provided by way of example but in no manner limited thereto, and shown by the attached drawings, in which:

FIG. 1 shows a front view of a vehicle steering wheel according to the present invention,

FIG. 2 shows a cross-sectional and elevation view of the vehicle steering wheel according to the present invention, with a lighting device,

FIG. 3 shows a cross-sectional and elevation view of the vehicle steering wheel according to a second embodiment, with the lighting device,

FIG. 4 shows a cross-sectional and elevation view of the vehicle steering wheel according to a third embodiment, with the lighting device,

FIG. 5 shows an isometric view of a lighting device housing compatible with the embodiments,

FIG. 6 shows a detail view of the steering wheel with a mask.

### DETAILED DESCRIPTION OF EMBODIMENT(S)

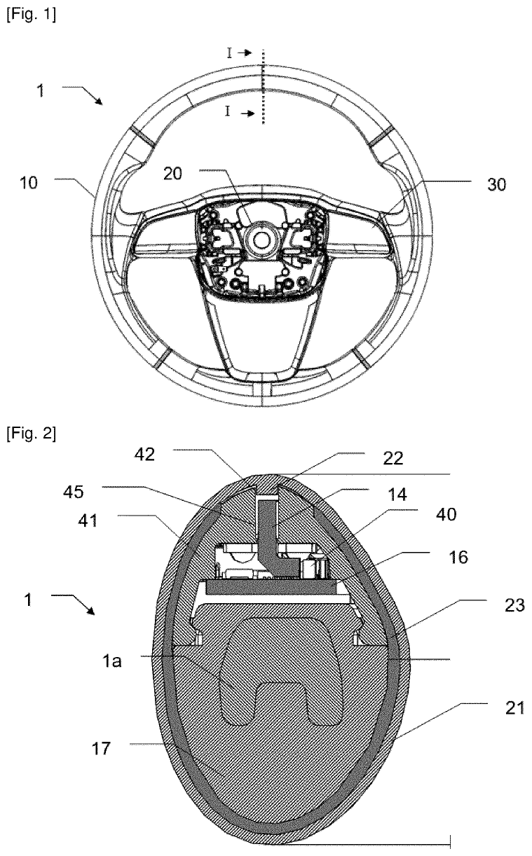

FIG. 1 shows a front view of a vehicle steering wheel 1.

FIG. 1 thus shows the vehicle steering wheel 1, which typically comprises a rim 10 connected to a hub 20 by one or more branches 30.

A cross-section I-I of the rim 10 is provided in order to show a cross-sectional view of the rim along I-I in FIG. 2. Section I-I is indicative and can be positioned at a different point on the steering wheel 1.

FIG. 2 shows a cross-sectional and elevation view of the vehicle steering wheel 1 according to the present invention, with a lighting device 40.

The vehicle steering wheel 1 thus comprises a frame 1a, the lighting device 40 which is arranged to emit light towards a user, such as a driver or passenger, a flexible cover element 21 and a support 41, such as a lighting device housing 41, or simply referred to as a housing 41.

The flexible cover element 21 is arranged to at least partially cover the lighting device 40, and the flexible cover element 21 is at least partially permeable to light, that is, it allows the user to see the light emitted by the lighting device 40 through the cover element 21.

The cover element 21 is arranged to be visible to a vehicle occupant.

The support 41 is arranged between the frame 1a and the flexible cover element 21. In this way, the support 41 supports the flexible cover element 21.

In the case where the support 41 is a lighting device housing 41, the housing 41 supports the lighting device 40 and the flexible cover element 21.

The flexible cover element 21 comprises at least one protuberance 22 arranged at least partially in at least one recess 42 of the support 41. This makes it possible to position the cover element 21 correctly on the steering wheel 1, and in particular with respect to the light from the lighting device 40 diffused towards a user.

In this way, the protuberance 22 allows the flexible cover element 21 to be centered with respect to the support 41 and the flexible cover element 21 to be precisely located.

The protuberance 22 is, for example, a protuberance or projection, preferably extending towards an inner side of the steering wheel 1, that is, towards the frame 1a.

Additionally, the protuberance 22 thus fills the recess 42.

In the example shown in FIG. 2, the protuberance 22 is further positioned opposite a light guide 14, so that it is correctly positioned opposite the light emitted by the lighting device 40 and then guided by the light guide 14.

The cover element 21 is preferably a sheath, and in particular made of plastic or leather, especially optical leather or artificial leather. The cover element 21 can then be considered as a decorative sheath.

The steering wheel 1 may further comprise an electrical sheath 23, which is an example of an electrical or electronic element separate from the lighting device 40. The electrical sheath 23 is preferably installed or mounted under the cover element 21 and at least partially on the support 41.

The electrical sheath 23 is sheathed under the cover element 21. The electrical sheath 23 is, for example, a presence sensor (capacitive, resistive or the like) and/or a heating element, or any other electrical or electronic device, the latter not being essential to the invention.

In this way, the cover element 21 covers the electrical sheath 23, which is partially supported by the foam or foaming 17 and/or the support 41.

In the upper or “12 o'clock” position, the rim 10 is equipped with the lighting device 40, corresponding to section I-I. It is possible to provide another position, and/or to provide several positions in order to provide several displays.

Note that the steering wheel 1 further comprises a foam or foaming 17 covering the frame 1a.

The housing 41 can be fitted with one or more fastening elements, such as one or more hooks, to attach it to the frame 1a or to the foam 17 surrounding the frame 1a.

The lighting device 40 may further comprise at least one light source arranged to emit light, such as one or more LEDs.

The lighting device 40 may further comprise a printed circuit board 16 (PCB) connected to the light source to support it and/or control it.

The printed circuit board 16 thus supports the light source, which transmits the emitted light to the user via the light guide 14.

FIG. 2 shows the vehicle steering wheel 1 with the underlying vehicle steering wheel frame 1a. Frame 1a refers to the carcass or framework designed to support the other components of the vehicle steering wheel (typically the overmolding or foaming, covering parts, controls such as horn controls, buttons, etc.).

The frame 1a can be made of magnesium, for example. However, it is possible to provide attached, screwed, welded or overmolded parts.

The frame 1a is then typically partially overmolded or covered with foam to conceal the metal parts from the driver, in particular or level with the branches 30 and the rim 10.

The steering wheel 1 can further comprise a decorative part, e.g. made of wood, carbon or plastic, which can be varnished.

The hub 20 can also be concealed, for example by an airbag module or a sheath.

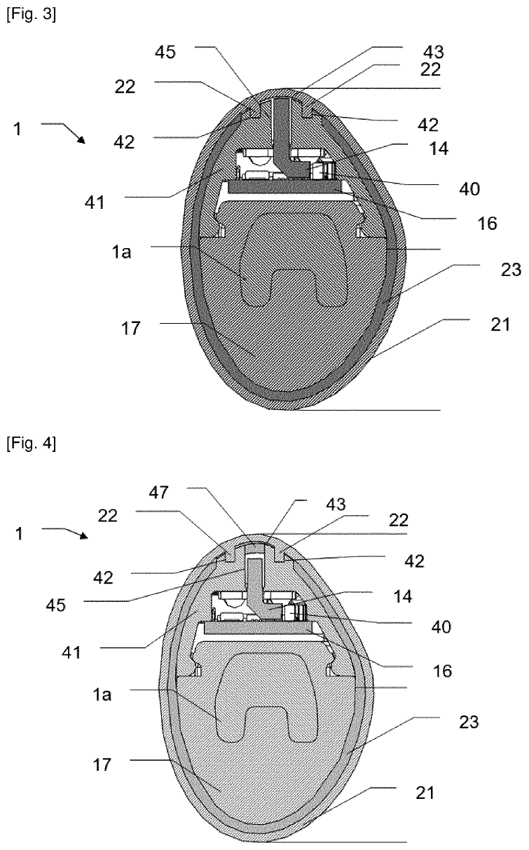

FIG. 3 shows a cross-sectional and elevation view of the vehicle steering wheel 1 according to a second embodiment, with the lighting device 40.

The embodiment shown in FIG. 3 differs from that shown in FIG. 2 in that the flexible cover element 21 comprises two protuberances 22, and these are not arranged opposite or facing the lighting device 40 or the diffusion zone of the light emitted by the lighting device 40, if this is guided by the light guide 14 (or an exit face of the light guide 14).

In the example shown in FIG. 3, the two protuberances 22 are arranged in the two recesses 42 of the support 41, on both sides of an opening 43 dedicated to the passage of light. The opening 43 is arranged opposite the lighting device 40 or the light guide 14 guiding the light from the lighting device 40 to a user.

In the example shown in FIG. 3, it is possible but not necessary for the cover element 23 to be permeable to light at the protuberances 22, whereas in the example shown in FIG. 2, it is necessary for the protuberance 22 to be at least partially permeable to light.

FIG. 4 shows a cross-sectional and elevation view of the vehicle steering wheel 1 according to a third embodiment, with the lighting device 40.

The embodiment of FIG. 4 differs from that of FIG. 3 in that the opening 43 houses a translucent support element 47, preferably independent of the electrical sheath 23. The translucent support 47 can be attached, overmolded or glued to the housing 41. This provides more precise support for the electrical sheath 23 (compared with the design shown in FIG. 3). Indeed, adjusting the light guide and the housing 41 is complicated.

In this case, the light travels from the lighting device 40, to the light guide 14, then to the translucent support 47 in the opening 43, then through the cover element 21.

It is further or alternatively possible to provide that the opening 43 houses part of the electrical sheath 23. In this case, the electrical sheath should also be at least partially permeable to light.

FIGS. 3 and 4 also show section I-I of the rim 10, but in different embodiments.

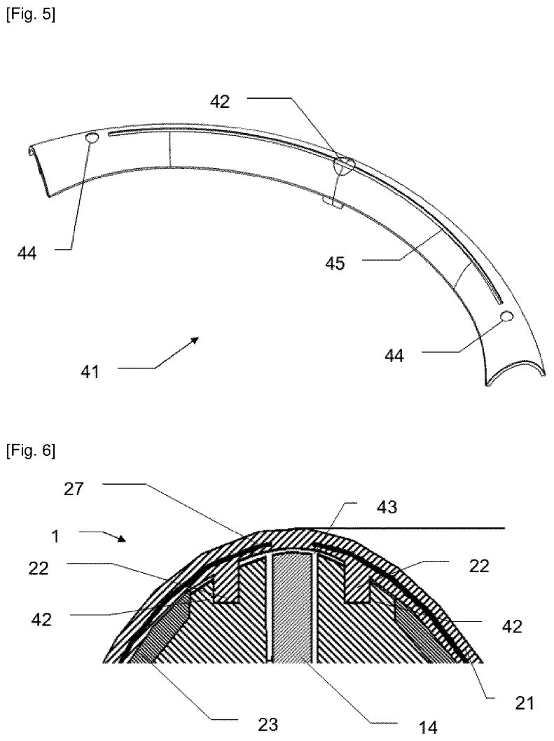

FIG. 5 shows an isometric view of the lighting device housing 41 compatible with the embodiments.

The lighting device support 41 or housing 41 may comprise the recess 42 to receive the light-permeable protuberance 22.

The housing 41 can comprise a groove 45 to allow light from the lighting device 40 to pass through (via a light guide 14 if required).

The housing 41 may further comprise openings 44 arranged to receive protuberances 22, but these need not be light-permeable. Indeed, as the openings 44 are arranged outside the groove 45 area, the openings 44 may not be passed through by light from the lighting device.

FIG. 6 shows a detail view of the steering wheel 1 with a mask 27.

The cover element 21 can further comprise the mask 27, for example, to display a particular symbol or a clear, precise shape for the user's attention.

It should be noted that the mask 27 is narrower than the opening 43 of the housing 41 through which the light from the lighting device 40 (here guided by the light guide 14) passes. The embodiment of FIG. 6 is an adaptation of the embodiment of FIG. 3, with the addition of the mask 27. The mask 27 can also be added in other embodiments.

Finally, it is possible to combine the embodiments, wherever possible and/or necessary.

It will be understood that various modifications and/or improvements which are obvious for the person skilled in the art may be made to the different embodiments of the invention described in this present description without departing from the scope of the invention defined by the appended claims.

An additional element can be provided on or above the flexible cover element 21.

The lighting device 40 may also comprise a diffuser (or light diffuser), not shown, arranged to diffuse light coming from the light source towards a vehicle occupant. The diffuser can be integrated into the cover element 21.

### LIST OF REFERENCE SIGNS

1 steering wheel
1 a frame
10 rim
14 light guide
16 printed circuit board
17 foam or foaming
20 hub
21 cover element, cover or cover sheath
22 protuberance
23 electrical sheath
27 mask
30 steering wheel branch
40 lighting device
41 support or housing
42 recess or opening
43, 44 openings
45 groove

1-10. (canceled)

11. A vehicle steering wheel comprising:
a frame,
a lighting device arranged to emit light towards a user,
a flexible cover element at least partially covering the lighting device, the flexible cover element being at least partially permeable to light, and
a support arranged between the frame and the flexible cover element,
wherein the flexible cover element comprises at least one protuberance arranged at least partially in at least one recess of the support.

12. The vehicle steering wheel according to claim 11, wherein the flexible cover element is a sheath.

13. The vehicle steering wheel according to claim 11, where in the cover element comprises a mask, which is preferably arranged so as to face a light diffusion region of the lighting device.

14. The vehicle steering wheel according to claim 11, wherein the at least one protuberance is permeable to light.

15. The vehicle steering wheel according to claim 11, wherein the at least one protuberance is arranged in a region through which the light of the lighting device does not pass.

16. The vehicle steering wheel according to claim 11, wherein the at least one protuberance is formed or imprinted entirely with the flexible cover element.

17. The vehicle steering wheel according to claim 11, wherein the at least one protuberance is overmolded or glued on the flexible cover element.

18. The vehicle steering wheel according to claim 11, further comprising an electrical element which is separate from the lighting device and has an opening arranged to house the at least one protuberance.

19. The vehicle steering wheel according to claim 11, further comprising a housing having a housing opening which is arranged to house the at least one protuberance, and preferably the housing opening is arranged to diffuse the light of the lighting device.

20. A motor vehicle comprising a vehicle steering wheel according to claim 11.
